(19) United States
(12) Patent Application Publication
(10) Pub. No.: US 2023/0277278 A1
(43) Pub. Date: Sep. 7, 2023

(54) SYSTEMS AND METHODS FOR GENERATING TOOTH REPRESENTATIONS

(71) Applicant: SmileDirectClub LLC, Nashville, TN (US)

(72) Inventors: Evgeny Gorbovskoy, Moscow (RU); Sergey Nikolskiy, Nashville, TN (US)

(73) Assignee: SmileDirectClub LLC, Nashville, TN (US)

(21) Appl. No.: 17/687,081

(22) Filed: Mar. 4, 2022

(51) Int. Cl. A61C 7/00; A61C 13/34; G06T 19/20

(52) U.S. Cl. CPC A61C 7/002; A61C 13/34; G06T 19/20; G06T 2219/2021; G06T 2219/2016; G06T 2219/2004

(57) ABSTRACT

A system includes one or more processors configured to receive a first three-dimensional (3D) representation of a dentition where the first 3D representation includes a plurality of tooth portions each representing a crown of a tooth in the dentition, identify, for each of the plurality of tooth portions, a corresponding tooth reference model from a data source, morph each of the tooth reference models based on the corresponding tooth portion for the crown in the dentition to generate a morphed tooth representation for the teeth in the dentition, where the morphed tooth representations have a morphed tooth portion that substantially matches the corresponding tooth portion representing the crowns of the teeth in the dentition from the first 3D representation, generate a second 3D representation of the dentition including each of the morphed tooth representations.

### TECHNICAL FIELD

The present disclosure relates generally to the field of dental imaging and treatment, and more specifically, to systems and methods for generating tooth representations.

### BACKGROUND

Dental impressions and associated physical or digital reproductions of a patient's teeth can be used by dentists or orthodontists to diagnose or treat an oral condition, such as the misalignment of the patient's teeth. In some instances, to obtain treatment for misalignment, a patient may receive an intraoral scan or administer dental impressions, which may be used for determining an initial position of the patient's teeth. However, an intraoral scan or dental impressions may not capture data relating to obscured portions of the patient's teeth, such as roots which are concealed by the patient's gingiva or interproximal areas which are obscured by adjacent teeth.

### SUMMARY

In one aspect, this disclosure is directed to a method. The method includes receiving, by one or more processors, a first three-dimensional (3D) representation of a dentition, wherein the first 3D representation includes a plurality of tooth portions each having a crown portion. The method further includes identifying, by the one or more processors, for each of the plurality of tooth portions, a corresponding tooth reference model from a data source. The method further includes morphing, by the one or more processors, each of the tooth reference models based on the respective corresponding tooth portion to generate morphed tooth representations, where the morphed tooth representations have a morphed tooth portion that at least substantially matches the corresponding tooth portion from the first 3D representation. The method further includes generating, by the one or more processors, a second 3D representation of the dentition including each of the morphed tooth representations.

In another aspect, this disclosure is directed to a system. The system includes one or more processors configured to receive a first three-dimensional (3D) representation of a dentition, where the first 3D representation includes a plurality of tooth portions each having a crown portion. The one or more processors are further configured to identify, for each of the plurality of tooth portions, a corresponding tooth reference model from a data source. The one or more processors are further configured to morph each of the tooth reference models based on the respective corresponding tooth portion to generate morphed tooth representations, where the morphed tooth representations have a morphed tooth portion that at least substantially matches the corresponding tooth portion from the first 3D representation. The one or more processors are further configured to generate a second 3D representation of the dentition including each of the morphed tooth representations.

In yet another aspect, this disclosure is directed to a non-transitory computer readable medium that stores instructions. The instructions, when executed by one or more processors, cause the one or more processors to receive a first three-dimensional (3D) representation of a dentition, where the first 3D representation includes a plurality of tooth portions each having a crown portion. The instructions further cause the one or more processors to identify, for each of the plurality of tooth portions, a corresponding tooth reference model from a data source. The instructions further cause the one or more processors to morph each of the tooth reference models based on the respective corresponding tooth portion to generate morphed tooth representations, where the morphed tooth representations have a morphed tooth portion that at least substantially matches the corresponding tooth portion from the first 3D representation. The instructions further cause the one or more processors to generate a second 3D representation of the dentition including each of the morphed tooth representations.

Various other embodiments and aspects of the disclosure will become apparent based on the drawings and detailed description of the following disclosure.

### BRIEF DESCRIPTION OF THE DRAWINGS

FIG. 1 shows a system for orthodontic treatment, according to an illustrative embodiment.

FIG. 2 shows a process flow of generating a treatment plan, according to an illustrative embodiment.

FIG. 3 shows a top-down simplified view of a model of a dentition, according to an illustrative embodiment.

FIG. 4 shows a perspective view of a three-dimensional model of the dentition of FIG. 3, according to an illustrative embodiment.

FIG. 5 shows a trace of a gingiva-tooth interface on the model shown in FIG. 3, according to an illustrative embodiment.

FIG. 6 shows a selection of teeth in a tooth model generated from the model shown in FIG. 5, according to an illustrative embodiment.

FIG. 7 shows a segmented tooth model of an initial position of the dentition shown in FIG. 3, according to an illustrative embodiment.

FIG. 8 shows a perspective view of a three-dimensional model of a segmented tooth of the dentition shown in FIG. 3, according to an illustrative embodiment.

FIG. 9 shows a front view of a three-dimensional model of the segmented tooth model shown in FIG. 7, according to an illustrative embodiment.

FIG. 10 shows a progression of the three-dimensional model of the segmented tooth model shown in FIG. 9, according to an illustrative embodiment.

FIG. 11 shows a plurality of landmarks of a crown of a tooth reference model, according to an illustrative embodiment.

FIG. 12 shows a comparison of a tooth portion and a tooth reference model, according to an illustrative embodiment.

FIG. 13 shows a target final position of the dentition from the initial position of the dentition shown in FIG. 7, according to an illustrative embodiment.

FIG. 14 shows a three-dimensional representation of a dentition, according to an illustrative embodiment.

FIG. 15 shows a series of stages of the dentition from the initial position shown in FIG. 7 to the target final position shown in FIG. 13, according to an illustrative embodiment.

FIG. 16 shows a diagram of a method of generating a three-dimensional representation of a dentition, according to an illustrative embodiment.

FIG. 17 shows a diagram of a method of generating a treatment plan based on a three-dimensional representation of a dentition, according to an illustrative embodiment.

### DETAILED DESCRIPTION

The present disclosure is directed to systems and methods for generating tooth representations for purposes of planning orthodontic treatment. More specifically, the present disclosure is directed to systems and methods for restoring portions of a tooth from a 3D scan that are incomplete or missing. For example, a scan of a person's mouth can include data associated with crowns of teeth and the gums or gingiva within the mouth. However, the scan may be missing information or data associated with roots of the teeth and interproximal areas between the teeth (e.g., where the teeth contact each other). The systems and methods disclosed herein can fill the gaps in the data to generate a full or complete 3D representation (e.g. a digital model) associated with the teeth.

For example, and according to one or more embodiments, a tooth from the scan is matched with a corresponding tooth from a teeth library. The library tooth is then morphed such that the crown (or coronal) portion of the library tooth matches the corresponding crown portion of the scanned tooth. The library tooth comprises all the requisite information of the tooth such that the root of the library tooth is transformed as the crown portion of the library tooth is transformed to match the crown portion of the scanned tooth. Therefore, when the crown portion of the library tooth matches the crown portion of the scanned tooth, the other portions of the library tooth (e.g., the roots, the interproximal areas, etc.) following morphing should provide a relatively accurate representation of the corresponding portions of the scanned tooth. The result is a complete 3D representation of a tooth without missing portions, with a root and a correct topology that substantially matches a visible portion of the scanned tooth. This can be applied to any tooth, since the teeth library may contain many different possible teeth models which can be matched to corresponding scanned teeth. While reference is made to matching the crown of the library tooth with the crown portion of the scanned tooth here and throughout the application for ease of reference, it will be appreciated that the library tooth can also or otherwise be morphed such that another portion of the library tooth matches a corresponding portion of the scanned tooth (e.g., a facial area of the tooth).

The complete 3D representations of the teeth can be used to generate a treatment plan to move a patient's teeth from an initial position to a desired final position. The complete 3D representations of the teeth are used to generate a 3D representation of a patient's dentition that represents the current state of the patient's teeth. Another 3D representation is then generated to represent the desired final state of the patient's teeth (e.g., realigning the teeth). Depending on the magnitude of correction between the current state and the final state, intermediate 3D representations may be generated to represent intermediate stages of the patient's teeth between the current state and the final state. The 3D representations may then be used to fabricate aligners for the patient to use to execute the treatment plan.

The systems and methods described herein may have many benefits over existing computing systems. Some embodiments may reduce the amount of information needed to be input (e.g., scan data) in order to create the desired output (e.g., full tooth representations). For example, since a tooth library can provide information regarding various aspects of a tooth, the initial scan of the teeth can be a smaller file with fewer details (as compared with, for example, x-ray data or other depth-related data for representing the roots). This can result in faster uploads of information and use of less memory space. Some embodiments also generate more accurate results when generating treatment plans. For example, generating a digital dentition representation that includes a full tooth representation, rather than just a portion of a tooth, may provide a more accurate representation of how the teeth can move and interact with each other and the gingiva of the dentition representation. This may result in fewer instances where a tooth does not move as desired and defined in a treatment plan. Planning treatment using just a crown, or a portion of a crown, may not provide the detail needed to model how teeth can actually move within a mouth. Various other technical benefits and advantages are described in greater detail below.

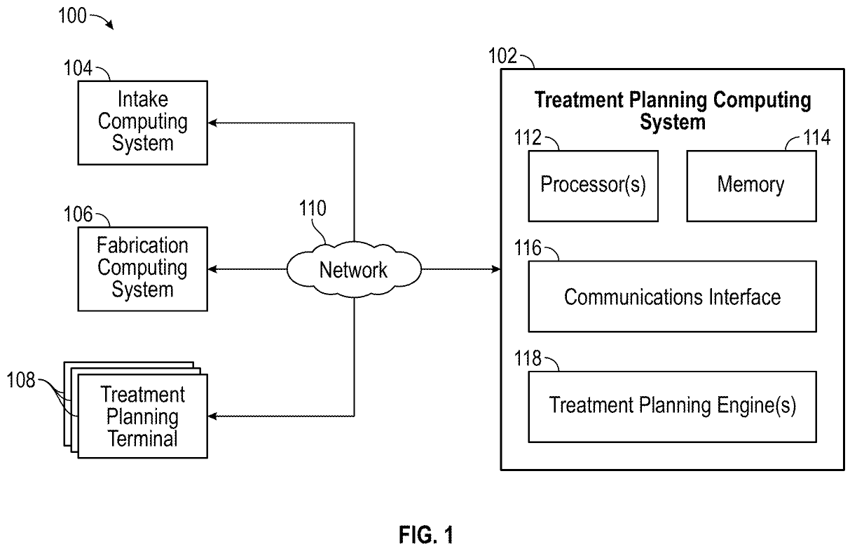

Referring to FIG. 1, a system 100 for orthodontic treatment is shown, according to an illustrative embodiment. As shown in FIG. 1, the system 100 includes a treatment planning computing system 102 communicably coupled to an intake computing system 104, a fabrication computing system 106, and one or more treatment planning terminals 108. In some embodiments, the treatment planning computing system 102 may be or may include one or more servers which are communicably coupled to a plurality of computing devices. In some embodiments, the treatment planning computing system 102 may include a plurality of servers, which may be located at a common location (e.g., a server bank) or may be distributed across a plurality of locations. The treatment planning computing system 102 may be communicably coupled to the intake computing system 104, fabrication computing system 106, and/or treatment planning terminals 108 via a communications link or network 110 (which may be or include various network connections configured to communicate, transmit, receive, or otherwise exchange data between addresses corresponding to the computing systems 102, 104, 106). The network 110 may be a Local Area Network (LAN), a Wide Area Network (WAN), a Wireless Local Area Network (WLAN), an Internet Area Network (IAN) or cloud-based network, etc. The network 110 may facilitate communication between the respective components of the system 100, as described in greater detail below.

The computing systems 102, 104, 106 include one or more processing circuits, which may include processor(s) 112 and memory 114. The processor(s) 112 may be a general purpose or specific purpose processor, an application specific integrated circuit (ASIC), one or more field programmable gate arrays (FPGAs), a group of processing components, or other suitable processing components. The processor(s) 112 may be configured to execute computer code or instructions stored in memory 114 or received from other computer readable media (e.g., CDROM, network storage, a remote server, etc.) to perform one or more of the processes described herein. The memory 114 may include one or more data storage devices (e.g., memory units, memory devices, computer-readable storage media, etc.) configured to store data, computer code, executable instructions, or other forms of computer-readable information. The memory 114 may include random access memory (RAM), read-only memory (ROM), hard drive storage, temporary storage, non-volatile memory, flash memory, optical memory, or any other suitable memory for storing software objects and/or computer instructions. The memory 114 may include database components, object code components, script components, or any other type of information structure for supporting the various activities and information structures described in the present disclosure. The memory 114 may be communicably connected to the processor 112 via the processing circuit, and may include computer code for executing (e.g., by processor(s) 112) one or more of the processes described herein.

The treatment planning computing system 102 is shown to include a communications interface 116. The communications interface 116 can be or can include components configured to transmit and/or receive data from one or more remote sources (such as the computing devices, components, systems, and/or terminals described herein). In some embodiments, each of the servers, systems, terminals, and/or computing devices may include a respective communications interface 116 which permit exchange of data between the respective components of the system 100. As such, each of the respective communications interfaces 116 may permit or otherwise enable data to be exchanged between the respective computing systems 102, 104, 106. In some implementations, communications device(s) may access the network 110 to exchange data with various other communications device(s) via cellular access, a modem, broadband, Wi-Fi, satellite access, etc. via the communications interfaces 116.

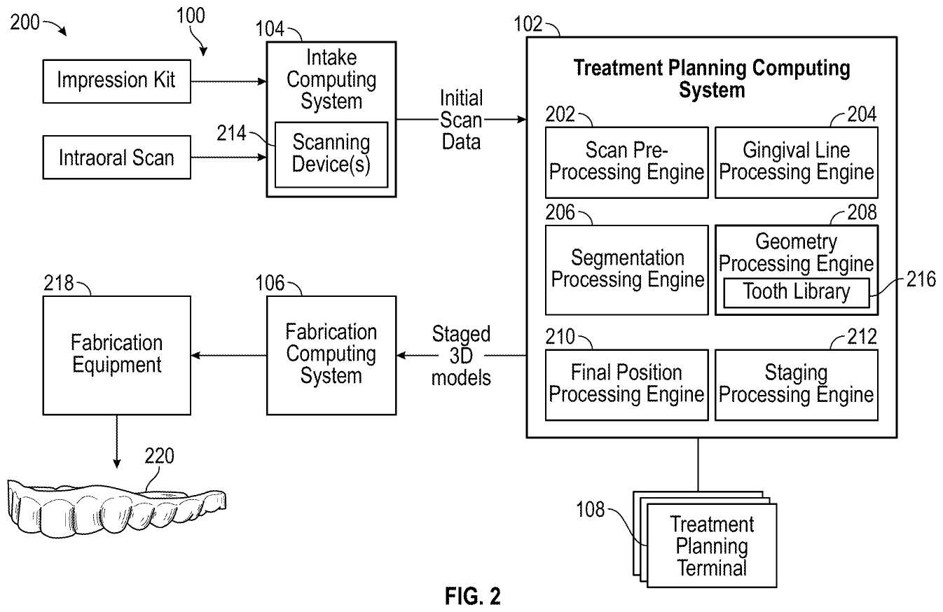

Referring now to FIG. 1 and FIG. 2, the treatment planning computing system 102 is shown to include one or more treatment planning engines 118. Specifically, FIG. 2 shows a treatment planning process flow 200 which may be implemented by the system 100 shown in FIG. 2, according to an illustrative embodiment. The treatment planning engine(s) 118 may be any device(s), component(s), circuit(s), or other combination of hardware components designed or implemented to receive inputs for and/or automatically generate a treatment plan from an initial three-dimensional (3D) representation of a dentition. In some embodiments, the treatment planning engine(s) 118 may be instructions stored in memory 114 which are executable by the processor(s) 112. In some embodiments, the treatment planning engine(s) 118 may be stored at the treatment planning computing system 102 and accessible via a respective treatment planning terminal 108. As shown in FIG. 2, the treatment planning computing system 102 may include a scan pre-processing engine 202, a gingival line processing engine 204, a segmentation processing engine 206, a geometry processing engine 208, a final position processing engine 210, and a staging processing engine 212. While these engines 202-212 are shown in FIG. 2, it is noted that the system 100 may include any number of treatment planning engines 118, including additional engines which may be incorporated into, supplement, or replace one or more of the engines shown in FIG. 2.

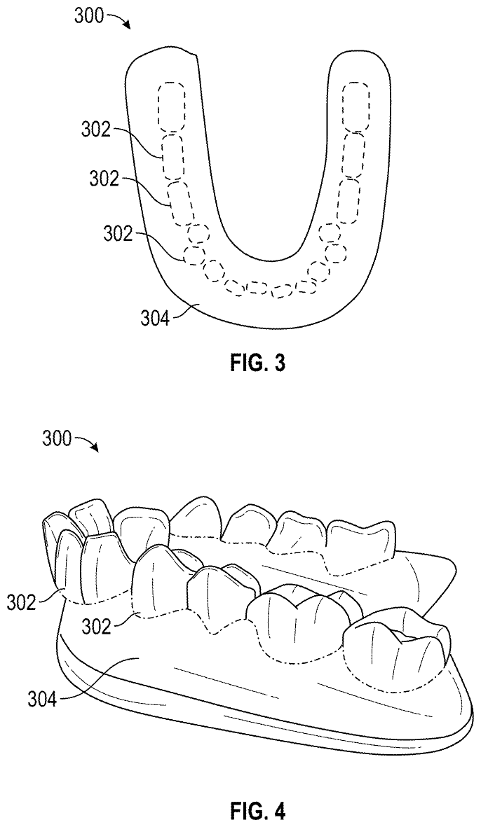

Referring to FIG. 2-FIG. 4, the intake computing system 104 may be configured to generate a 3D model of a dentition. Specifically, FIG. 3 and FIG. 4 show a simplified top-down view and a side perspective view of a 3D model of a dentition, respectively, according to illustrative embodiments. In some embodiments, the intake computing system 104 may be communicably coupled to or otherwise include one or more scanning devices 214. The intake computing system 104 may be communicably coupled to the scanning devices 214 via a wired or wireless connection. The scanning devices 214 may be or include any device, component, or hardware designed or implemented to generate, capture, or otherwise produce a 3D model 300 of an object, such as a dentition or dental arch. In some embodiments, the scanning devices 214 may include intraoral scanners configured to generate a 3D model of a dentition of a patient as the intraoral scanner passes over the dentition of the patient. For example, the intraoral scanner may be used during an intraoral scanning appointment, such as the intraoral scanning appointments described in U.S. Provisional Patent Application No. 62/660,141, titled “Arrangements for Intraoral Scanning,” filed Apr. 19, 2018, and U.S. patent application Ser. No. 16/130,762, titled “Arrangements for Intraoral Scanning,” filed Sep. 13, 2018, the contents of each of which are incorporated herein by reference in their entirety. In some embodiments, the scanning devices 214 may include 3D scanners configured to scan a dental impression. The dental impression may be captured or administered by a patient using a dental impression kit similar to the dental impression kits described in U.S. Provisional Patent Application No. 62/522,847, titled “Dental Impression Kit and Methods Therefor,” filed Jun. 21, 2017, and U.S. patent application Ser. No. 16/047,694, titled “Dental Impression Kit and Methods Therefor,” filed Jul. 27, 2018, the contents of each of which are incorporated herein by reference in their entirety. In these and other embodiments, the scanning devices 214 may generally be configured to generate a 3D digital model of a dentition of a patient. The scanning device(s) 214 may be configured to generate a 3D digital model of the upper (i.e., maxillary) dentition and/or the lower (i.e., mandibular) dentition of the patient. The 3D digital model may include a digital representation of the patient's teeth 302 and gingiva 304. The scanning device(s) 214 may be configured to generate 3D digital models of the patient's dentition prior to treatment (i.e., with their teeth in an initial position). In some embodiments, the scanning device(s) 214 may be configured to generate the 3D digital models of the patient's dentition in real-time (e.g., as the dentition/impression) is scanned. In some embodiments, the scanning device(s) 214 may be configured to export, transmit, send, or otherwise provide data obtained during the scan to an external source which generates the 3D digital model, and transmits the 3D digital model to the intake computing system 104. In some embodiments, the intake computing system 104 is configured to generate the 3D digital model from one or more 2D images of the patient's dentition. For example, the patient themselves or someone else can capture one or more images of the patient's dentition using a digital camera, such as a camera system on a mobile phone or tablet, and then transmit or upload the one or more images to the intake computing system 104 for processing into the 3D digital model. The images captured by the patient, or someone assisting the patient, can be 2D photographs, videos, or a 3D photograph. The 3D digital model generation based on the one or more 2D images may be similar to the 3D digital model generation described in U.S. patent application Ser. No. 16/696,468, titled “Systems and Methods for Constructing a Three-Dimensional Model from Two-Dimensional Images,” filed Nov. 26, 2019, and U.S. patent application Ser. No. 17/247,055, titled “Systems and Methods for Constructing a Three-Dimensional Model from Two-Dimensional Images,” filed Nov. 25, 2020, the contents of each of which are incorporated herein by reference in their entirety.

The intake computing system 104 may be configured to transmit, send, or otherwise provide the 3D digital model to the treatment planning computing system 102. In some embodiments, the intake computing system 104 may be configured to provide the 3D digital model of the patient's dentition to the treatment planning computing system 102 by uploading the 3D digital model to a patient file for the patient. The intake computing system 104 may be configured to provide the 3D digital model of the patient's upper and/or lower dentition at their initial (i.e., pre-treatment) position. The 3D digital model of the patient's upper and/or lower dentition may together form initial scan data which represents an initial position of the patient's teeth prior to treatment.

The treatment planning computing system 102 may be configured to receive the initial scan data from the intake computing system 104 (e.g., from the scanning device(s) 214 directly, indirectly via an external source following the scanning device(s) 214 providing data captured during the scan to the external source, etc.). As described in greater detail below, the treatment planning computing system 102 may include one or more treatment planning engines 118 configured or designed to generate a treatment plan based on or using the initial scan data.

Referring to FIG. 2, the treatment planning computing system 102 is shown to include a scan pre-processing engine 202. The scan pre-processing engine 202 may be or include any device(s), component(s), circuit(s), or other combination of hardware components designed or implemented to modify, correct, adjust, or otherwise process initial scan data received from the intake computing system 104 prior to generating a treatment plan. The scan pre-processing engine 202 may be configured to process the initial scan data by applying one or more surface smoothing algorithms to the 3D digital models. The scan pre-processing engine 202 may be configured to fill one or more holes or gaps in the 3D digital models. In some embodiments, the scan pre-processing engine 202 may be configured to receive inputs from a treatment planning terminal 108 to process the initial scan data. For example, the scan pre-processing engine 202 may be configured to receive inputs to smooth, refine, adjust, or otherwise process the initial scan data.

The inputs may include a selection of a smoothing processing tool presented on a user interface of the treatment planning terminal 108 showing the 3D digital model(s). As a user of the treatment planning terminal 108 selects various portions of the 3D digital model(s) using the smoothing processing tool, the scan pre-processing engine 202 may correspondingly smooth the 3D digital model at (and/or around) the selected portion. Similarly, the scan pre-processing engine 202 may be configured receive a selection of a gap filling processing tool presented on the user interface of the treatment planning terminal 108 to fill gaps in the 3D digital model(s).

In some embodiments, the scan pre-processing engine 202 may be configured to receive inputs for removing a portion of the gingiva represented in the 3D digital model of the dentition. For example, the scan pre-processing engine 202 may be configured to receive a selection (on a user interface of the treatment planning terminal 108) of a gingiva trimming tool which selectively removes gingival from the 3D digital model of the dentition. A user of the treatment planning terminal 108 may select a portion of the gingiva to remove using the gingiva trimming tool. The portion may be a lower portion of the gingiva represented in the digital model opposite the teeth. For example, where the 3D digital model shows a mandibular dentition, the portion of the gingiva removed from the 3D digital model may be the lower portion of the gingiva closest to the lower jaw. Similarly, where the 3D digital model shows a maxillary dentition, the portion of the gingiva removed from the 3D digital model may be the upper portion of the gingiva closest to the upper jaw.

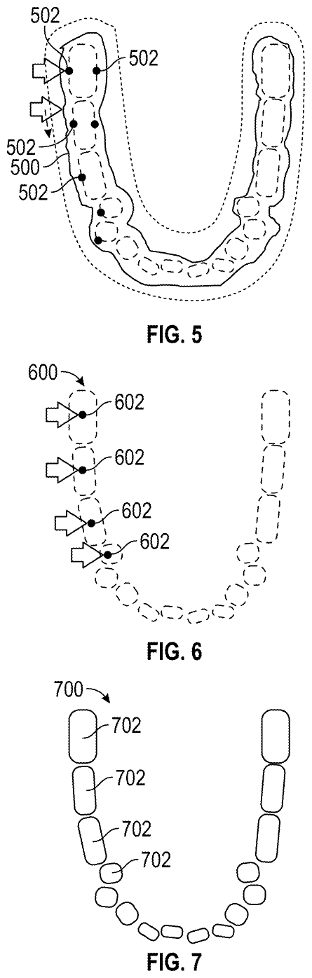

Referring now to FIG. 2 and FIG. 5, the treatment planning computing system 102 is shown to include a gingival line processing engine 204. Specifically, FIG. 5 shows a trace of a gingiva-tooth interface on the model 300 shown in FIG. 3 and FIG. 4. The gingival line processing engine 204 may be or include any device(s), component(s), circuit(s), or other combination of hardware components designed or implemented to determine, identify, or otherwise define a gingival line of the 3D digital models. The gingival line may be or include the interface between the gingiva and teeth represented in the 3D digital models. In some embodiments, the gingival line processing engine 204 may be configured to receive inputs from the treatment planning terminal 108 for defining the gingival line. The treatment planning terminal 108 may show a gingival line defining tool on a user interface which includes the 3D digital models.

The gingival line defining tool may be used for defining or otherwise determining the gingival line for the 3D digital models. As one example, the gingival line defining tool may be used to trace a rough gingival line 500. For example, a user of the treatment planning terminal 108 may select the gingival line defining tool on the user interface, and drag the gingival line defining tool along an approximate gingival line of the 3D digital model. As another example, the gingival line defining tool may be used to select (e.g., on the user interface shown on the treatment planning terminal 108) lowest points 502 at the teeth-gingiva interface for each of the teeth in the 3D digital model.

The gingival line processing engine 204 may be configured to receive the inputs provided by the user via the gingival line defining tool on the user interface of the treatment planning terminal 108 for generating or otherwise defining the gingival line. In some embodiments, the gingival line processing engine 204 may be configured to use the inputs to identify a surface transition on or near the selected inputs. For example, where the input selects a lowest point 502 (or a portion of the gingival line 500 near the lowest point 502) on a respective tooth, the gingival line processing engine 204 may identify a surface transition or seam at or near the lowest point 502 which is at the gingival margin. The gingival line processing engine 204 may define the transition or seam as the gingival line. The gingival line processing engine 204 may define the gingival line for each of the teeth included in the 3D digital model 300. The gingival line processing engine 204 may be configured to generate a tooth model using the gingival line of the teeth in the 3D digital model 300. The gingival line processing engine 204 may be configured to generate the tooth model by separating the 3D digital model along the gingival line. The tooth model may be the portion of the 3D digital model which is separated along the gingival line and includes digital representations of the patient's teeth.

Referring now to FIG. 2 and FIG. 6, the treatment planning computing system 102 is shown to include a segmentation processing engine 206. Specifically, FIG. 6 shows a view of the tooth model 600 generated by the gingival line processing engine 204. The segmentation processing engine 206 may be or include any device(s), component(s), circuit(s), or other combination of hardware components designed or implemented to determine, identify, or otherwise segment individual teeth from the tooth model. In some embodiments, the segmentation processing engine 206 may be configured to receive inputs (e.g., via a user interface shown on the treatment planning terminal 108) which select the teeth (e.g., points 602 on the teeth) in the tooth model 600. For example, the user interface may include a segmentation tool which, when selected, allows a user to select points 602 on each of the individual teeth in the tooth model 600. In some embodiments, the selection of each of the teeth may also assign a label to the teeth. The label may include tooth numbers (e.g., according to FDI world dental federation notation, the universal numbering system, Palmer notation, etc.) for each of the teeth in the tooth model 600. As shown in FIG. 6, the user may select individual teeth in the tooth model 600 to assign a label to the teeth.

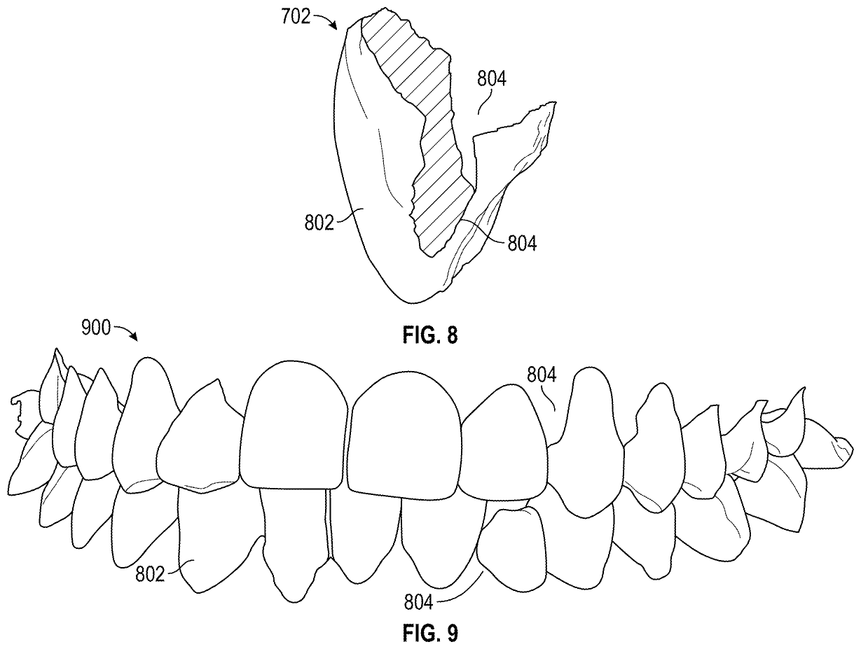

Referring now to FIG. 7, depicted is a segmented tooth model 700 generated from the tooth model 600 shown in FIG. 6. The segmentation processing engine 206 may be configured to receive the selection of the teeth from the user via the user interface of the treatment planning terminal 108. The segmentation processing engine 206 may be configured to separate each of the teeth selected by the user on the user interface. For example, the segmentation processing engine 206 may be configured to identify or determine a gap between two adjacent points 602. The segmentation processing engine 206 may be configured to use the gap as a boundary defining or separating two teeth. The segmentation processing engine 206 may be configured to define boundaries for each of the teeth in the tooth model 600. The segmentation processing engine 206 may be configured to generate the segmented tooth model 700 including segmented teeth 702 using the defined boundaries generated from the selection of the points 602 on the teeth in the tooth model 600.

Referring now to FIGS. 2, 8, and 9, the treatment planning computing system 102 is shown to include a geometry processing engine 208. The geometry processing engine 208 may be or may include any device(s), component(s), circuit(s), or other combination of hardware components designed or implemented to determine, identify, or otherwise generate tooth models for each of the teeth in the 3D digital model. Once the segmentation processing engine 206 generates the segmented tooth model 700, the geometry processing engine 208 may be configured to use the segmented teeth to generate a tooth model for each of the segmented teeth. Since the teeth have been separated along the gingival line by the gingival line processing engine 204 (as described above with reference to FIG. 6), the segmented teeth may only include crowns (e.g., the segmented teeth may not include any roots) or portions of the crowns and other areas of the teeth (e.g., interproximal surfaces between two teeth may be missing). An exemplary segmented tooth 702 is shown in FIG. 8. The segmented tooth 702 may include a tooth portion 802. The tooth portion 802 may be a representation of the data associated with the teeth 302 of the dentition that was obtained by the scanning device 214. Segmented tooth 702 may also include one or more missing portions 804. The missing portions 804 may include areas where data was not obtained, or limited data was obtained, or data was obscured, by the scanning device (e.g., as part of scanning a patient's teeth directly or as part of scanning a dental impression of the patient's teeth, for instance). For example, the missing portion 804 may include a missing root of the tooth 302, a missing interproximal surface (e.g., surface between two teeth), or any other portion for which the scanning device 214 has missing or incomplete data. For example, segmented tooth 702 may comprise a crown of a tooth, but may be missing a portion of the crown if the portion of the crown is not visible or is not detected by a scanning device 214 when gathering the initial dentition data. For example, the missing portions 804 on the side of the segmented tooth 702 may represent an interproximal area of the tooth. The interproximal area of the tooth may have been in contact with a neighboring tooth such that the scanning device 214 could not detect data associated with that area. As another example, the segmented tooth 702 does not include a root of the tooth. When obtaining the initial scan data, the roots of the teeth may be covered by the gingiva and thus may not be detectable by the scanning device 214 (e.g., since the only the gingiva would be captured during the intraoral scan or during an impression).

FIG. 9 shows a full 3D dentition representation 900 comprising all of the segmented teeth 702 based on the original dentition data. The full 3D dentition representation 900 includes the teeth portions 802 of the respective teeth 302 as well as the missing portions 804. The full 3D dentition representation 900 may be a representation of all the teeth data obtained via the scanning device 214. The geometry processing engine 208 may configured to generate tooth representations which fill in the missing portions 804 for each of the respective teeth.

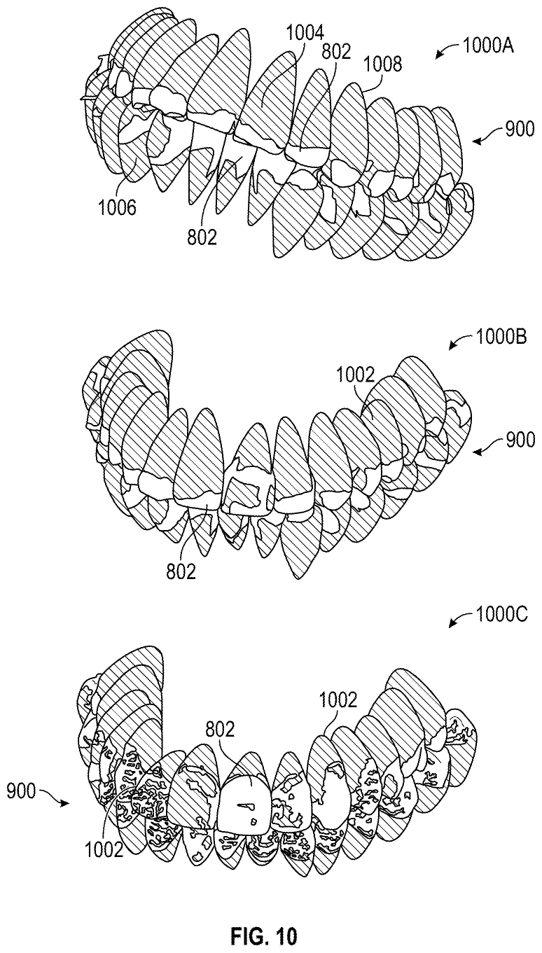

Referring now to FIG. 2 and FIG. 10, the geometry processing engine 208 may be configured to generate at least one tooth representation 1002 using the corresponding segmented tooth 702. The tooth representation 1002 may include a crown 1004 (or a portion of a crown 1004). The tooth representation 1002 may also include a root 1006 of a tooth 302. For example, the tooth representation 1002 may be a “whole” tooth representation that includes both a crown 1004 and a root 1006. In another example, the tooth representation 1002 is a “partial” tooth representation that includes a crown 1004 or a partial crown 1004 but not a root 1006. The tooth representation 1002 may also include a representation of an interproximal area or space of a tooth 302. For example, the geometry processing engine 208 may be configured to fill in the portions of the segmented tooth 702 that were not a part of the initial scan data. In some embodiments, the geometry processing engine 208 may be configured to generate the tooth representation 1002 using the labels assigned to each of the segmented teeth 702. For example, the geometry processing engine 208 may be configured to access a tooth library 216. The tooth library 216 may include a library or database having a plurality of tooth reference models 1008. The plurality of tooth reference models 1008 may include tooth reference models 1008 for each of the types of teeth in a dentition (e.g., molars, premolars, cuspids, incisors, etc.). The plurality of tooth reference models 1008 may be labeled or grouped according to tooth numbers. Each of the tooth reference models 1008 may include a crown (or a portion of a crown). Each of the tooth reference models 1008 may also include a root of a tooth. For example, each of the tooth reference models 1008 may be a “whole” tooth reference model that includes both a crown and a root. In another example, a tooth reference model 1008 is a “partial” tooth reference model that includes a crown or a partial crown but not a root.

The geometry processing engine 208 may be configured to generate the tooth representations 1002 for a segmented tooth 702 by performing a look-up function in the tooth library 216 using the label assigned to the segmented tooth 702 (as described above with reference to FIG. 6-FIG. 7) to identify a corresponding tooth reference model 1008. The geometry processing engine 208 may be configured to morph the tooth reference model 1008 identified in the tooth library 216. The morphed tooth representations 1002 may correspond to the shape (e.g., surface contours) of the segmented teeth 702. For example, morphing a tooth reference model 1008 may include identifying a tooth reference model 1008 that corresponds to a tooth portion 802 of the full 3D dentition representation 900. For example, a first tooth portion 802 with a first label from the scan may correspond to a first tooth reference model 1008 with the same first label. After matching a tooth portion 802 with a tooth reference model 1008, the geometry processing engine 208 may be configured to dispose the tooth reference model 1008 at a location within the full 3D dentition representation 900 that is close to a location of the tooth portion 802.

The geometry processing engine 208 may be configured to align a first surface of the tooth reference model 1008 with a corresponding surface of the tooth portion 802. For example, the geometry processing engine 208 may be configured to align a local occlusal plane of the first tooth reference model 1008 with a local occlusal plane of the first tooth portion 802. Once aligned, the geometry processing engine 208 may be configured to deform the tooth reference model 1008 (e.g., shrink, extend, reorient, reposition, etc.) such that the shape, size, and orientation of a portion of the tooth reference model 1008 that resembles the tooth portion 802 matches the tooth portion 802. For example, the geometry processing engine 208 may transform a crown of the tooth representation 1002 such that the crown or crown portion matches the size, shape, and orientation of the corresponding tooth portion 802. For example, geometry processing engine 208 may be configured to scale an occlusal face of the first tooth reference model 1008 to match a scale of an occlusal face of the first tooth portion 802. As the crown of the tooth representation 1002 changes to mimic the tooth portion 802, other parts of the tooth reference model 1008 (e.g., a root) may also change accordingly. For example, as the occlusal face of the first tooth reference model 1008 is scaled to match the scale of the occlusal face of the first tooth portion 802, the root of the first tooth reference model 1008 may be scaled proportionately with the occlusal face of the first tooth reference model 1008. As such, when the crown of the tooth reference model 1008 at least substantially matches the original tooth portion 802, the root and interproximal surfaces of the tooth reference model 1008 provide an accurate representation of the missing portions 804 from the full 3D dentition representation 900.

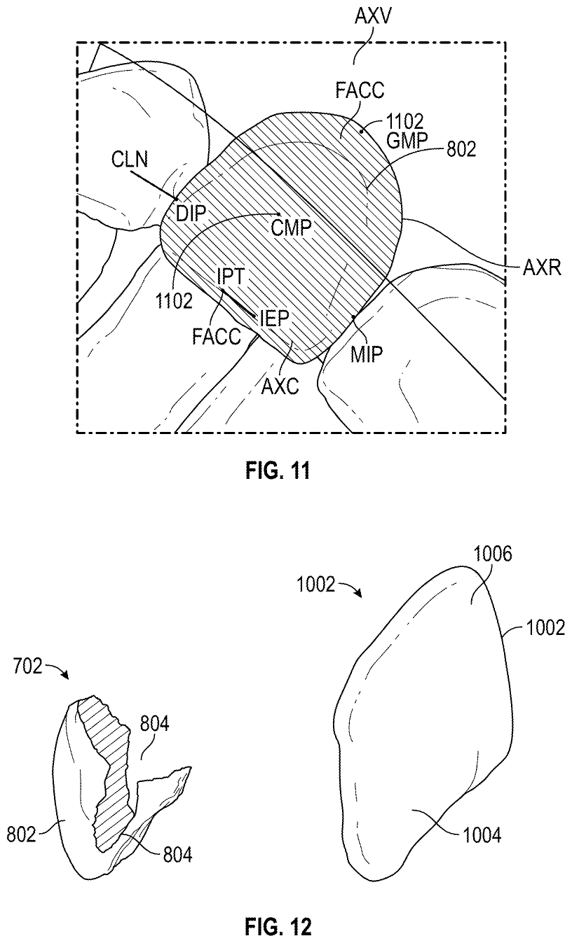

Referring now to FIG. 11, in some embodiments, other surfaces, curvatures, positions, etc. can be used as reference points to match the tooth reference model 1008 with the tooth portion 802. For example, a tooth portion 802 may have, or be labeled with, landmarks 1102 (e.g., specific reference points) that correspond to landmarks of the tooth representation 1002. Aligning the landmarks may assist in morphing the tooth representation 1002 to match the size, shape, and orientation of the tooth portion 802. For example, the tooth portion 802 shown in FIG. 11 includes a plurality of landmarks 1102. A landmark 1102 may refer to, for example, a contact midpoint (CMP), a gingival margin point (GMP), a mesial interproximal point (MIP), a distal interproximal point (DIP), a vestibular axis (AXV), a facial axis of clinical crown (FACC), a root axis (AXR), a crown axis (AXC), an incisal edge point (IEP), an incisal point (IPT), and a contact line normal (CLN), among other possible landmarks. The geometry processing engine 208 may be configured to align one, some, all, or none of these landmarks of the tooth portion 802 with corresponding landmarks of the tooth reference model 1008.

Referring back to FIG. 10, a progression of images 1000A-1000C of the morphing of the tooth reference model 1008 to generate the tooth representation 1002 is shown, according to an exemplary embodiment. For example, the first image 1000A shows each of the teeth portions 802 of the full 3D dentition representation 900 having a corresponding tooth reference model 1008. Each tooth reference model 1008 is disposed proximate to its corresponding tooth portion 802. To start, the tooth reference models 1008 may cover a majority of the teeth portions 802. The second and third images 1000B, 1000C show examples of how the tooth reference models 1008 change as they are reconfigured to match the size, shape, and orientation of the corresponding tooth portions 802. For example, more of the teeth portions 802 are visible because the tooth reference model 1008 has been modified and no longer covers the tooth portion 802. The roots of the tooth reference model 1008 may also be modified based on the modifications of the crowns of the tooth reference model 1008. By matching the tooth reference model 1008 with the teeth portions 802 and morphing the tooth reference model 1008 to substantially match the teeth portions 802, the geometry processing engine 208 may be configured to generate a 3D representation of the dentition including each of the morphed tooth representations 1002. The morphed tooth representations 1002 provide data regarding the missing portions 804 that were present in the previous full 3D dentition representation 900.

In some embodiments, the geometry processing engine 208 may be configured to generate the tooth representation 1002 by stitching the morphed tooth representation 1002 based on the tooth reference model 1008 from the tooth library 216 to the segmented tooth 702, such that the tooth representation 1002 includes a portion (e.g., a root portion) from the tooth reference model 1008 and a portion (e.g., a crown portion) from the segmented tooth 702. In some embodiments, the geometry processing engine 208 may be configured to generate a tooth representation 1002 by replacing the segmented tooth 702 with the morphed tooth reference model 1008 from the tooth library. In these and other embodiments, the geometry processing engine 208 may be configured to generate tooth representations 1002, including crowns, roots, and interproximal surfaces, for each of the teeth 302 in a 3D representation. The tooth representation 1002 of each of the teeth 302 in the 3D representation may depict, show, or otherwise represent an initial position of the patient's dentition.

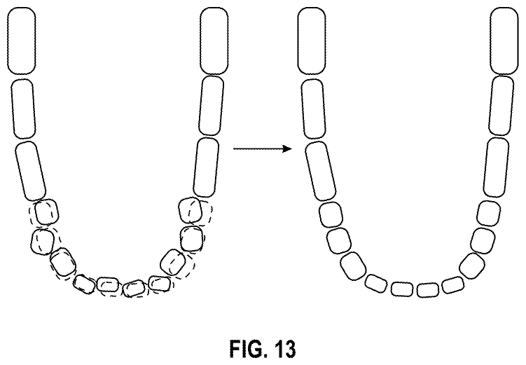

Referring now to FIG. 12, a comparison of a segmented tooth 702 and a tooth representation 1002 are shown, according to an exemplary embodiment. The segmented tooth 702 may include a tooth portion 802 and at least one missing portion 804. For example, a first missing portion 804 may correspond to missing root data and a second missing portion 804 may correspond to missing interproximal space data. For example, if two teeth 302 are overlapping or contacting each other, the scanning device 214 may not detect data associated with the teeth 302 at the contact points. For another example, the gingiva 304 of the dentition may cover at least a portion of the root 1006 of the tooth 302 such that the scanning device 214 may not detect data associated with the root 1006. The tooth representation 1002 fills in the gaps initially present in the data received from the scanning device 214. The tooth representation 1002 may include a crown 1004 and a root 1006, with all interproximal data included for both the crown 1004 and the root 1006. As shown in FIG. 10, the crown 1004 of the tooth representation 1002 is reconfigured such that the geometry of the crown 1004 substantially matches the geometry of the tooth portion 802. The root 1006 of the tooth representation 1002 is adjusted according to the adjustments made to match the tooth portion 802, such that the root 1006 provides a relatively accurate representation of what the interproximal portions and the root of the original scanned tooth 302 look like.

Referring now to FIG. 2 and FIG. 13, the treatment planning computing system 102 is shown to include a final position processing engine 210. Specifically, FIG. 13 shows one example of a target final position of the dentition from the initial position of the dentition shown in FIG. 7. The final position processing engine 210 may be or may include any device(s), component(s), circuit(s), or other combination of hardware components designed or implemented to determine, identify, or otherwise generate a final position of the patient's teeth. The final position processing engine 210 may be configured to generate the treatment plan by manipulating individual 3D models of teeth within the 3D model (e.g., shown in FIG. 7, among others). In some embodiments, the final position processing engine 210 may be configured to receive inputs for generating the final position of the patient's teeth. The final position may be a target position of the teeth post-orthodontic treatment or at a last stage of realignment. A user of the treatment planning terminal 108 may provide one or more inputs for each tooth or a subset of the teeth in the initial 3D model to move the teeth from their initial position to their final position (shown in dot-dash). For example, the treatment planning terminal 108 may be configured to receive inputs to drag, shift, rotate, or otherwise move individual teeth to their final position, incrementally shift the teeth to their final position, etc. The movements may include lateral/longitudinal movements, rotational movements, translational movements, etc.

In various embodiments, the manipulation of the 3D model may show a final (or target) position of the teeth of the patient following orthodontic treatment or at a last stage of realignment via dental aligners. In some embodiments, the final position processing engine 210 may be configured to apply one or more movement thresholds (e.g., a maximum lateral and/or rotational movement for treatment) to each of the individual 3D teeth models for generating the final position. As such, the final position may be generated in accordance with the movement thresholds.

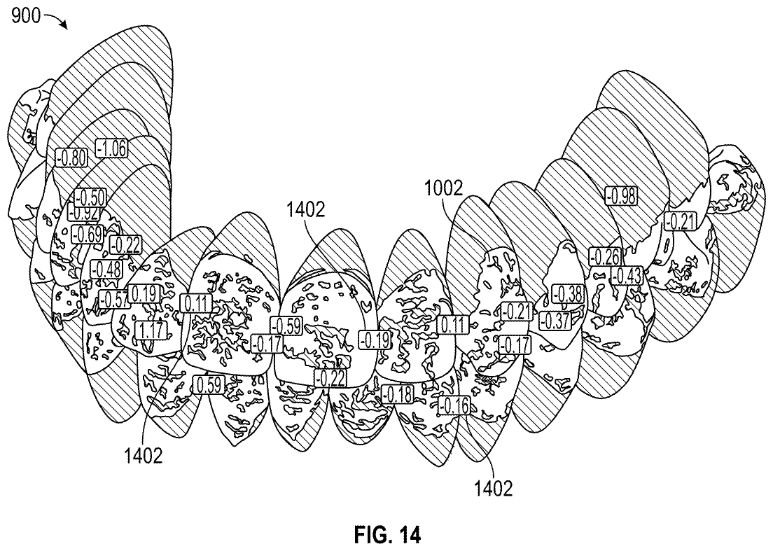

Referring now to FIG. 2 and FIG. 14, the final position processing engine 210 may be configured to identify an interproximal distance 1402. The interproximal distance 1402 may be a distance between two adjacent teeth 302. In one embodiment, the interproximal distance 1402 may be positive when there is open space between the teeth 302. In some embodiments, the interproximal distance 1402 may be negative when the teeth overlap or contact each other. The final position processing engine 210 may be configured to determine a displacement for the tooth representations 1002 based on the interproximal distance 1402 identified. For example, the final position processing engine 210 may compare the interproximal distance 1402 to a predetermined value (or range). When the interproximal distance 1402 does not exceed the predetermined value, the final position processing engine 210 may determine a displacement of zero. When the interproximal distance 1402 does exceed the predetermined value, the final position processing engine 210 may determine a displacement to correct the interproximal distance 1402 such that a final interproximal distance 1402 satisfies the predetermined value. The final position processing engine 210 may use the displacement when generating the final position of the tooth representation 1002. In some embodiments, other processing engines may be configured to identify interproximal distances 1402. For example, the segmentation processing engine 206 may be configured to determine an interproximal distance 1402 between the segmented teeth 702 from the initial scan data.

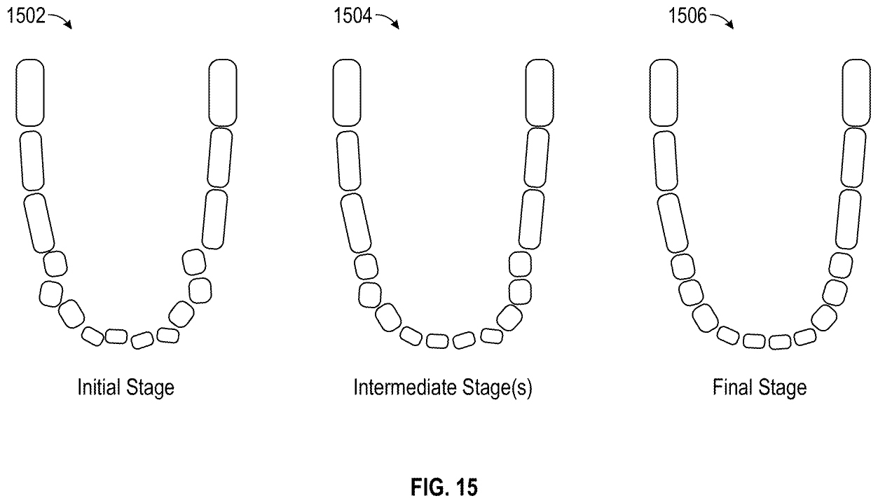

Referring now to FIG. 2 and FIG. 15, the treatment planning computing system 102 is shown to include a staging processing engine 212. Specifically, FIG. 15 shows a series of stages of the dentition from the initial position shown in FIG. 7 to the target final position shown in FIG. 13, according to an illustrative embodiment. The staging processing engine 212 may be or include any device(s), component(s), circuit(s), or other combination of hardware components designed or implemented to determine, identify, or otherwise generate stages of treatment from the initial position to the final position of the patient's teeth. In some embodiments, the staging processing engine 212 may be configured to receive inputs (e.g., via a user interface of the treatment planning terminal 108) for generating the stages. In some embodiments, the staging processing engine 212 may be configured to automatically compute or determine the stages based on the movements from the initial to the final position. The staging processing engine 212 may be configured to apply one or more movement thresholds (e.g., a maximum lateral and/or rotational movement for a respective stage) to each stage of treatment plan. The staging processing engine 212 may be configured to generate the stages as 3D representations of the patient's teeth as they progress from their initial position to their final position. For example, and as shown in FIG. 15, the stages may include an initial stage 1502 including a 3D representation of the patient's teeth at their initial position, one or more intermediate stages 1504 including 3D representation(s) of the patient's teeth at one or more intermediate positions, and a final stage 1506 including a 3D representation of the patient's teeth at the final position. During each stage, the staging processing engine 212 may manipulate the tooth representations 1002 such that the tooth representations 1002 are repositioned from an initial position (e.g., based on the original dentition data) to a final position, with any number of intermediate positions.

In some embodiments, the staging processing engine 212 may be configured to generate at least one intermediate stage 1504 for each tooth 302 based on a difference between the initial position of the tooth 302 and the final position of the tooth 302. For instance, where the staging processing engine 212 generates one intermediate stage, the intermediate stage may be a halfway point between the initial position of the tooth 302 and the final position of the tooth 302. Each of the stages may together form a treatment plan for the patient, and may include a series or set of 3D representations.

Following generating the stages, the treatment planning computing system 102 may be configured to transmit, send, or otherwise provide the staged 3D representations to the fabrication computing system 106. In some embodiments, the treatment planning computing system 102 may be configured to provide the staged 3D representations to the fabrication computing system 106 by uploading the staged 3D representations to a patient file which is accessible via the fabrication computing system 106. In some embodiments, the treatment planning computing system 102 may be configured to provide the staged 3D representations to the fabrication computing system 106 by sending the staged 3D representations to an address (e.g., an email address, IP address, etc.) for the fabrication computing system 106.

The fabrication computing system 106 can include a fabrication computing device and fabrication equipment 218 configured to produce, manufacture, or otherwise fabricate dental aligners. The fabrication computing system 106 may be configured to receive a plurality of staged 3D digital models corresponding to the treatment plan for the patient. As stated above, each 3D digital model may be representative of a particular stage of the treatment plan (e.g., a first 3D model corresponding to an initial stage of the treatment plan, one or more intermediate 3D models corresponding to intermediate stages of the treatment plan, and a final 3D model corresponding to a final stage of the treatment plan).

The fabrication computing system 106 may be configured to send the staged 3D representations to fabrication equipment 218 for generating, constructing, building, or otherwise producing dental aligners 220. In some embodiments, the fabrication equipment 218 may include a 3D printing system. The 3D printing system may be used to 3D print physical models corresponding the 3D models of the treatment plan. As such, the 3D printing system may be configured to fabricate physical models which represent each stage of the treatment plan. In some implementations, the fabrication equipment 218 may include casting equipment configured to cast, etch, or otherwise generate physical models based on the 3D representations of the treatment plan. Where the 3D printing system generates physical models, the fabrication equipment 218 may also include a thermoforming system. The thermoforming system may be configured to thermoform a polymeric material to the physical models, and cut, trim, or otherwise remove excess polymeric material from the physical models to fabricate a dental aligner. In some embodiments, the 3D printing system may be configured to directly fabricate dental aligners 220 (e.g., by 3D printing the dental aligners 220 directly based on the 3D representations of the treatment plan). Additional details corresponding to fabricating dental aligners 220 are described in U.S. Provisional Patent Application No. 62/522,847, titled “Dental Impression Kit and Methods Therefor,” filed Jun. 21, 2017, and U.S. patent application Ser. No. 16/047,694, titled “Dental Impression Kit and Methods Therefor,” filed Jul. 27, 2018, and U.S. Pat. No. 10,315,353, titled “Systems and Methods for Thermoforming Dental Aligners,” filed Nov.13, 2018, the contents of each of which are incorporated herein by reference in their entirety.

The fabrication equipment 218 may be configured to generate or otherwise fabricate dental aligners 220 for each stage of the treatment plan. In some instances, each stage may include a plurality of dental aligners 220 (e.g., a plurality of dental aligners 220 for the first stage of the treatment plan, a plurality of dental aligners 220 for the intermediate stage(s) of the treatment plan, a plurality of dental aligners 220 for the final stage of the treatment plan, etc.). Each of the dental aligners 220 may be worn by the patient in a particular sequence for a predetermined duration (e.g., two weeks for a first dental aligner 220 of the first stage, one week for a second dental aligner 220 of the first stage, etc.).

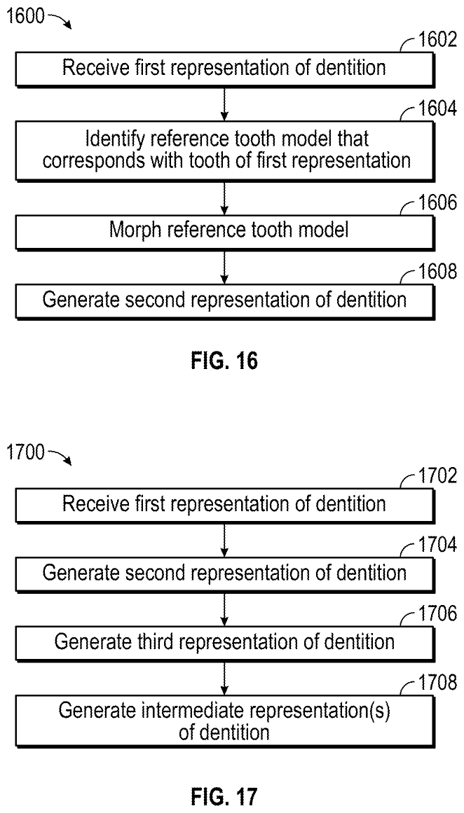

Referring now to FIG. 16, a method 1600 of generating a representation of a dentition comprising whole tooth data is shown, according to an exemplary embodiment. The whole tooth data may include data regarding all portions of a tooth 302 including the root, crown, interproximal surfaces, etc. The generated representation may comprise a morphed tooth representation 1002 that substantially matches a tooth portion 802 from a previously received representation. The morphed tooth representation 1002 may include other parts of the tooth 302 that were not visible, not present, or incomplete in the previously received representation. In some embodiments, the method 1600 comprises receiving a first representation of a dentition (step 1602), identifying a tooth reference model that corresponds with a tooth portion of the first representation (step 1604), morphing the tooth reference model (step 1606), and generating a second representation of the dentition (step 1608). At step 1602, one or more processors may receive a first three-dimensional (3D) representation of a dentition. For example, the geometry processing engine 208 may receive the 3D representation of the dentition. The 3D representation of the dentition may be obtained via an intake computing system 104 as described above with reference to FIG. 1-FIG. 2. The intake computing system 104 may be a part of the treatment planning computing system 102, or may be separate from the treatment planning computing system 102. In some embodiments, a scanning device 214 of the intake computing system 104 may generate or provide data corresponding to a dentition. The data can be used to create the first 3D representation of the dentition.

The 3D representation of the dentition may include the teeth 302 and the gingiva 304 as shown in FIG. 4, among others. The teeth 302 may be a plurality of tooth portions 802 representing a crown, or partial crown, of a tooth. For example, a root of a tooth 302 may be missing or not visible in the 3D representation of the dentition due to being covered by the gingiva 304 (e.g., the scanning device 214 cannot detect data corresponding to the root of the tooth 302). The crowns of the teeth 302 may also be incomplete. For example, where a first tooth 302 contacts a second tooth 302, the 3D representation may not include any data corresponding to interproximal surfaces of both the first tooth 302 and the second tooth 302. Therefore, with incomplete crown and root data, the 3D representation may include a plurality of tooth portions 802 and a plurality of missing portions 804.

At step 1604, one or more processors may generate a second 3D representation of the dentition. To generate the second 3D representation, the one or more processors may identify a tooth reference model 1008 from a data source (e.g., the tooth library 216) that corresponds to a tooth portion 802. In some embodiments, the one or more processors may identify a tooth reference model 1008 for each of the plurality of tooth portions 802. In some embodiments, the geometry processing engine 208 may identify the tooth reference model 1008 for each of the plurality of tooth portions 802. Identifying a tooth reference model 1008 that corresponds to a tooth portion 802 may include identifying the position of the tooth portion 802 with respect to the dentition. The position of the tooth portion may indicate which type of tooth the tooth portion 802 corresponds to, which may determine which tooth reference model 1008 corresponds to the tooth portion 802. For example, if the tooth portion 802 is one of the front two teeth on the lower jaw of the dentition, the tooth portion 802 corresponds to a central incisor. As such, the tooth representation 1002 that corresponds with the tooth portion 802 may be a central incisor. Step 1604 may also include labeling the tooth portion as such.

Identifying the tooth reference model 1008 that corresponds to the tooth portion 802 may also include selecting the tooth reference model 1008 from a database. For example, the tooth reference model 1008 may be selected from tooth library 216. The tooth library 216 may be a database comprising a plurality of tooth reference models 1008. At least one of the plurality of tooth reference models 1008 corresponds to each of the types of teeth in a dentition. Each of the types of teeth in the tooth library 216 may be labeled or grouped according to a tooth number, or other universal organizational scheme, in order to determine which tooth reference model 1008 from the tooth library 216 corresponds to which tooth portion 802. The tooth reference models 1008 from the tooth library 216 may provide data corresponding to the missing portions 804 of the tooth that are not provided in the previously received 3D representation of the dentition.

At step 1606, one or more processors may morph a tooth reference model 1008 based on the corresponding tooth portion 802 from the first 3D representation to generate a morphed tooth representation 1002 for the teeth 302 in the dentition. In some embodiments, the one or more processors may morph a plurality of tooth reference models 1008, wherein each of the plurality of tooth reference models 1008 correspond to a respective tooth portion 802. In some embodiments, the geometry processing engine morphs a plurality of tooth reference models 1008. A morphed tooth representation 1002 may have a morphed tooth portion that substantially matches a corresponding tooth portion 802 representing the crown of the tooth in the first 3D representation of the dentition. For example, the tooth reference model 1008 may transform to match the shape, size, and orientation of the corresponding tooth portion 802 from the first 3D representation. As the tooth reference model 1008 transforms, other parts of the tooth reference model 1008 (e.g., the crown, root, etc.) may transform accordingly. As such, the morphed tooth representation 1002 may mimic the shape, size, and orientation of the corresponding tooth portion 802 representing the crown of the tooth from the first 3D representation and may provide data corresponding to the root and other portions of the crown that were not a part of the previously received 3D representation. Morphing can be applied to a single tooth reference model 1008, each of the tooth reference models 1008, or a subset of the tooth reference models 1008.

In some embodiments, morphing the tooth reference model 1008 at step 1606 may include aligning, by one or more processors, a first local occlusal plane of a tooth reference model 1008 with a second local occlusal plan of a corresponding tooth portion 802.

In some embodiments, morphing the tooth reference models 1008 at step 1606 may include scaling, by one or more processors, an occlusal face of the tooth reference model 1008 to match a scale of an occlusal face of the corresponding tooth portion 802. For example, if the occlusal face of the tooth portion 802 is smaller (e.g., has a smaller area) than the occlusal face of the tooth reference model 1008, the occlusal face of the tooth reference model 1008 will be scaled to match the size of the occlusal face of the tooth portion 802.

In some embodiments, morphing the tooth reference models 1008 at step 1606 may include applying, by one or more processors, at least one of a displacement and a rotation to one or more points on the tooth reference model 1008 to match a corresponding closest point for the corresponding tooth portion 802.

In some embodiments, morphing the tooth reference models 1008 at step 1606 may include aligning, by one or more processors, a set of points from both the tooth representation 1002 and the corresponding tooth portion 802. The set of points may be aligned based on a determined offset of the set of points between the tooth representation 1002 and the corresponding tooth portion 802. In some embodiments, the set of points refers to a landmark. For example, morphing the tooth reference model 1008 may include aligning a landmark of the tooth reference model 1008 with a corresponding landmark of the corresponding tooth portion 802. For example, a mesial interproximal point of the tooth reference model 1008 may be aligned with a mesial interproximal point of the tooth portion 802. In some embodiments, a plurality of landmarks of the tooth reference model 1008 are aligned with a corresponding plurality of landmarks of the tooth portion 802.

In some embodiments, morphing the tooth reference models 1008 at step 1606 may include applying, by one or more processors, a Laplacian attraction of the tooth representation 1002 to a boundary of the corresponding tooth portion 802. In some embodiments, morphing the tooth reference models 1008 at step 1606 may include applying, by one or more processors, a Laplacian attraction of a crown portion of the tooth reference model 1008 to the crown portion represented by the corresponding tooth portion 802.

In some embodiments, morphing tooth reference models 1008 at step 1606 may include projecting, by one or more processors, points of the tooth reference model 1008 onto the corresponding tooth portion 802. In some embodiments, to morph each of the tooth reference models 1008, one or more processors iteratively perform at least one of the plurality of steps.

In some embodiments, once the tooth reference model 1008 has been morphed to match the corresponding tooth portion 802, one or more processors may smooth a surface of the morphed tooth representation 1002.

At step 1606, responsive to completing the morphing of the tooth reference model 1008, one or more processors may generate the second representation of the dentition including each of the morphed tooth representations 1002. For example, the second representation may include teeth 302, but the teeth 302 may be the morphed tooth representations 1002. The second representation may include all the data corresponding to all parts of the teeth due to the information of the tooth reference models 1008 identified from the data source. Therefore, the second representation may provide data regarding the roots and other non-visible parts of the teeth that the first representation did not provide.

In some embodiments, method 1600 includes generating, by one or more processors, a displacement for the morphed tooth representations 1002 based on an interproximal distance 1402 between two adjacent teeth 302. For example, a processor may identify an overlap between two adjacent teeth portions 802 in the first representation received at step 1602. The processor may generate a displacement for the tooth representations 1002 at an interproximal contact in the generated second representation. The one or more processors may also generate a displacement based on interproximal distances between the morphed tooth representations 1002 from the second representation generated at step 1608.

Referring now to FIG. 17, a method 1700 of generating a treatment plan is shown, according to an exemplary embodiment. The treatment plan may comprise a plurality of stages, wherein each stage comprises a new position for at least one tooth 302. In some embodiments, method 1700 comprises receiving a first representation of a dentition (step 1702), generating a second representation of the dentition (step 1704), generating a third representation of the dentition (step 1706), and generating intermediate representation(s) of the dentition (step 1708). At step 1702, similar to step 1602, one or more processors may receive a first 3D representation of a dentition. The first 3D representation may include the teeth 302 and the gingiva 304 as shown in FIG. 4, among others. Each tooth 302 may include a tooth portion 802 representing a crown, or partial crown, of a tooth.

At step 1704, one or more processors generate a second 3D representation of a dentition. In one embodiment, the second 3D representation may be generated according to steps 1604-1608, as described above. In such an embodiment, the second 3D representation may comprise a plurality of morphed tooth representations 1002. The morphed tooth representations 1002 may include a root 1006 and a crown 1004 for each tooth 302, where each of the crowns 1004 of the morphed tooth representations 1002 substantially match a tooth portion 802 of a corresponding tooth 302 of the first 3D representation received by the one or more processors. The second 3D representation represents the teeth 302 in an initial position.

At step 1706, one or more processors generate a third 3D representation of a dentition. The third 3D representation may be based on the second 3D representation. In one embodiment, the third 3D representation represents the teeth 302 of the dentition in a final position. For example, step 1706 may include determining, by one or more processors, a final position of the teeth 302 in the dentition. For example, the morphed tooth representations 1002 of the second 3D representation are repositioned into a final position. The final position may be an expected final tooth arrangement after the treatment plan has been executed.

At step 1708, one or more processors generate one or more intermediate 3D representations. The one or more intermediate 3D representations may represent a tooth position between the second 3D representation and the third 3D representation. For example, the one or more intermediate 3D representations include each of the morphed tooth representations 1002 progressing from the initial position to the final position. For example, the difference between the initial position and the final position may be too much to move in a single step. Therefore, the movement may be segmented into a plurality of steps, such that the movement in each step is less than the overall movement. For example, each of the morphed tooth representations 1002 may have an intermediate position before reaching the final position. There can be any number of intermediate positions before reaching the final position. In some embodiments, the difference between the initial positions of the teeth 302 and the final positions of the teeth 302 may be small enough such that there is no intermediate 3D representation.

In some embodiments, one or more processors may manufacture a dental aligner based on the intermediate 3D representation (if applicable) and the third 3D representation. The dental aligner may be configured to reposition the teeth of a patient from the initial position to each intermediate position (if applicable), and ultimately to the final position. For example, if there is one intermediate 3D representation generated at step 1708, the one or more processors may manufacture a first dental aligner configured to move the teeth from the initial position to an intermediate position associated with the one intermediate 3D representation. The one or more processors may also manufacture a second dental aligner configured to move the teeth from the intermediate position to the final position associated with the third 3D representation. There can be any number of intermediate positions, and therefore, any number of dental aligners manufactured.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the F. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems, apparatuses, and methods shown in the various exemplary embodiments is illustrative only. Additionally, any element disclosed in one embodiment may be incorporated or utilized with any other embodiment disclosed herein. For example, any of the exemplary embodiments described in this application can be incorporated with any of the other exemplary embodiment described in the application. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A method comprising:
receiving, by one or more processors, a first three-dimensional (3D) representation of a dentition, the first 3D representation including a plurality of tooth portions each having a crown portion;
identifying, by the one or more processors, for each of the plurality of tooth portions, a corresponding tooth reference model from a data source;
morphing, by the one or more processors, each of the tooth reference models based on the respective corresponding tooth portion to generate morphed tooth representations, the morphed tooth representations having a morphed tooth portion that at least substantially matches the corresponding tooth portion from the first 3D representation; and
generating, by the one or more processors, a second 3D representation of the dentition including each of the morphed tooth representations.

2. The method of claim 1, wherein the first 3D representation represents the teeth in an initial position, the method further comprising:
determining, by the one or more processors, a final position of the teeth in the dentition;
generating, by the one or more processors, a third 3D representation of the dentition from the second 3D representation, the third 3D representation including each of the morphed tooth representations in the final position; and
generating, by the one or more processors, one or more intermediate 3D representations between the second 3D representation and the third 3D representation, the one or more intermediate 3D representations including the morphed tooth representations progressing from the initial position to the final position.

3. The method of claim 2, further comprising:
manufacturing, by the one or more processors, one or more dental aligners based on the one or more intermediate 3D representations and the third 3D representation, the one or more dental aligners configured to reposition the teeth of a patient from the initial position to the final position.

4. The method of claim 1, wherein morphing each of the tooth reference models comprises:
aligning, by the one or more processors, a local occlusal plane of a first tooth reference model with a local occlusal plane of a first tooth portion; and
scaling, by the one or more processors, an occlusal face of the first tooth reference model to match a scale of an occlusal face of the first tooth portion.

5. The method of claim 4, further comprising applying, by the one or more processors, a displacement and rotation to one or more points on the first tooth reference model to match a corresponding closest point for the first tooth portion.

6. The method of claim 4, further comprising aligning, by the one or more processors, a set of points from both the first tooth reference model and the first tooth portion, wherein the set of points are aligned based on a determined offset of the set of points between the first tooth reference model and the first tooth portion.

7. The method of claim 4, further comprising applying, by the one or more processors, a Laplacian attraction of the first tooth reference model to a boundary of the first tooth portion.

8. The method of claim 4, further comprising applying, by the one or more processors, a Laplacian attraction of a crown portion of the first tooth reference model to the crown portion of the first tooth portion.

9. The method of claim 4, further comprising projecting, by the one or more processors, points of the first tooth reference model onto the first tooth portion.

10. The method of claim 1, further comprising smoothing, by the one or more processors, a surface of the morphed tooth representation.

11. The method of claim 1, further comprising:
identifying, by the one or more processors, an overlap between two adjacent teeth portions in the first 3D representation; and
generating, by the one or more processors, a displacement for the corresponding morphed teeth representations at an interproximal contact in the second 3D representation.

12. A system comprising:
one or more processors configured to:
receive a first three-dimensional (3D) representation of a dentition, the first 3D representation including a plurality of tooth portions each having a crown portion;
identify, for each of the plurality of tooth portions, a corresponding tooth reference model from a data source;
morph each of the tooth reference models based on the respective corresponding tooth portion to generate morphed tooth representations, the morphed tooth representations having a morphed tooth portion that at least substantially matches the corresponding tooth portion from the first 3D representation; and
generate a second 3D representation of the dentition including each of the morphed tooth representations.

13. The system of claim 12, wherein the first 3D representation represents the teeth in an initial position, and wherein the one or more processors are further configured to:
determine a final position of the teeth in the dentition;
generate a third 3D representation of the dentition from the second 3D representation, the third 3D representation including each of the morphed tooth representations in the final position; and
generate one or more intermediate 3D representations between the second 3D representation and the third 3D representation, the intermediate 3D representations including each of the morphed tooth representations progressing from the initial position to the final position.

14. The system of claim 13, further comprising:
manufacturing equipment configured to manufacture one or more dental aligners based on the one or more intermediate 3D representations and the third 3D representation, the one or more dental aligners configured to reposition the teeth of a patient from the initial position to the final position.

15. The system of claim 12, wherein to morph each of the tooth reference models, the one or more processors are configured to perform a plurality of steps comprising:
aligning, for a first tooth reference model and a corresponding first tooth portion, a first local occlusal plane for the first tooth reference model with a second local occlusal plane for the first tooth portion;
scaling an occlusal face of the first tooth reference model to match a scale of an occlusal face for the first tooth portion;
applying a displacement and rotation to one or more points on the first tooth reference model to match a corresponding closest point for the first tooth portion;
aligning a set of points from both the first tooth reference model and the first tooth portion, wherein the set of points are aligned based on a determined offset of the set of points between the first tooth reference model and the first tooth portion;
applying a first Laplacian attraction of the first tooth reference model to a boundary of the first tooth portion;
applying a second Laplacian attraction of a crown portion of the first tooth reference model to the crown portion of the first tooth portion; and
projecting points of the first tooth reference model onto the first tooth portion.

16. The system of claim 15, wherein to morph each of the tooth reference models, the one or more processors are configured to iteratively perform at least one of the plurality of steps.

17. The system of claim 12, wherein the one or more processors are further configured to smooth a surface of the morphed tooth representations.

18. The system of claim 12, wherein the one or more processors are further configured to:
identify an overlap between two adjacent teeth portions in the first 3D representation; and
generate a displacement for the corresponding morphed tooth representations at an interproximal contact in the second 3D representation.

19. A non-transitory computer readable medium storing instructions that, when executed by one or more processors, cause the one or more processors to:
receive a first three-dimensional (3D) representation of a dentition, the first 3D representation including a plurality of tooth portions each having a crown portion;
identify, for each of the plurality of tooth portions, a corresponding tooth reference model from a data source;
morph each of the tooth reference models based on the respective corresponding tooth portion to generate morphed tooth representations, the morphed tooth representations having a morphed tooth portion that at least substantially matches the corresponding tooth portion from the first 3D representation; and
generate a second 3D representation of the dentition including each of the morphed tooth representations.

20. The non-transitory computer readable medium of claim 19, wherein, to morph each of the tooth representations, the instructions are configured to cause the one or more processors to perform a plurality of steps comprising:
aligning, for a first tooth reference model and a corresponding first tooth portion, a first local occlusal plane of the first tooth reference model with a second local occlusal plane of the first tooth portion;
scaling an occlusal face of the first tooth reference model to match a scale of an occlusal face of the first tooth portion;
applying a displacement and rotation to one or more points on the first tooth reference model to match a corresponding closest point for the first tooth portion;
aligning a set of points from both the first tooth reference model and the first tooth portion, wherein the set of points are aligned based on a determined offset of the set of points between the first tooth reference model and the first tooth portion;
applying a first Laplacian attraction of the first tooth reference model to a boundary of the first tooth portion;
applying a second Laplacian attraction of a crown portion of the first tooth reference model to the crown portion represented by the first tooth portion; and
projecting points of the first tooth reference model onto the first tooth portion.
